(19) United States
(12) Patent Application Publication
(10) Pub. No.: US 2011/0111990 A1
(43) Pub. Date: May 12, 2011

(54) STRONG LOW DENSITY CERAMICS

(76) Inventors: Elena Mikhailovna Pershikova, Moscow (RU); Zinaida Yurievna Usova, Tomsk (RU); Svetlana Anatolyevna Naydukova, Novosibirsk (RU)

(21) Appl. No.: 12/989,547

(22) PCT Filed: Apr. 28, 2008
(86) PCT No.: PCT/RU2008/000268

§ 371 Date: Jan. 7, 2011

(51) Int. Cl. C09K 8/80

(52) U.S. Cl. 507/219; 507/273; 507/269; 507/270

(57) ABSTRACT

A synthetic ceramic proppant composition contains an aluminate-borate phase or an aluminate-borate-silicate phase or both and at least one additional phase that adds strength and decreases apparent specific gravity and is formed because of the inclusion of certain inorganic salts and/or metallic oxides in the precursor mixture either as separate components or as impurities in the starting materials. Compositions, methods of manufacture, and uses are given.

### BACKGROUND OF THE INVENTION

Some embodiments of the invention relate to oil-and-gas production, and in particular, to manufacture of proppants, i.e. ceramic granulated propping agents, that are used in hydraulic fracturing of hydrocarbon-containing formations for the purpose of increasing oil and gas recovery from wells.

Presently, primarily sand and various types of ceramic proppants made of various bauxite ores and clays or their mixtures are used in the practice of hydraulic fracturing of oil and gas formations. When the raw materials used to make these ceramics are calcined, aluminum oxide, aluminosilicates and various forms of silica (such as quartz and quartz glass) are generated in the phase composition of the material. The chemical compositions and the structures of these newly generated phases determine the propping agent strength, density and chemical durability, which, in turn, determine the major operating properties of proppant packing, namely, pack conductivity and permeability.

U.S. Pat. No. 4,894,285 describes a method in which a 2.75-3.4 g/cm³ density proppant which can be used at pressures of 2,000-10,000 psi (2.98-14.88 kPa) is made from a mixture of bauxites and clays and is burnt at temperatures of 1,350-1,550° C.

According to the method described in U.S. Pat. No. 4,921,821, proppant having a density below 3.0 g/cm³ can be made by granulation and subsequent calcining of kaolin clays.

According to the method described in U.S. Pat. No. 5,120,455, proppant having a density below 3.0 g/cm³ and forming a pack having a permeability over 100,000 millidarcies at 10,000 psi (14.88 kPa), is made of raw materials containing 40 to 60 percent aluminum oxide.

In accordance with U.S. Pat. No. 5,188,175, proppant having a density of 2.2-2.60 g/cm³ and forming a pack having a permeability exceeding the conductivity of sand is made of raw materials containing 25-40 weight percent of aluminum oxide.

The above mention references are all incorporated herein in their entirety, by reference thereto.

It is an object herein to provide proppants that have a combination of lower density and higher crush strength than has previously been available.

### SUMMARY

A first embodiment is a sintered spherical pellet ceramic proppant, prepared from a precursor mixture that includes at least a first component that is one or more than one of alumina, a mineral comprising aluminum oxide, an inorganic salt, a metallic oxide in which the metal is not all aluminum, an impure alumina, or a mixture of these materials. The first component cannot be only alumina (unless the second component contains a metal other than aluminum and boron, or there is a third component, see below) or only an inorganic salt (unless there is a source of aluminum). The precursor mixture also contains a second component that is a boron source. The proppant contains at least a first phase selected from aluminum borates, aluminum boron silicates, or solid solutions of these with alumina and aluminum silicate, and a second phase that adds strength and/or reduces density.

The first component may be selected from bauxites, kaolinites, clays, aluminas, aluminum hydroxides, alumina-containing metallurgy slags, micas, alumina-containing fluid cracking catalyst particles, aluminum silicates, alumina chlorides, alumina nitrides, alumina sulfates, alumina fluorides, alumina iodides, alumina bromides, aluminum borates, aluminum boron silicates, and mixtures of these materials. The second component may be selected from boric acids, boron oxides, hydrous tetraborates, anhydrous tetraborates, boron nitrides, boron carbides, colemanites, aluminum borates, zinc borates, calcium borates, magnesium borates, and mixtures of these materials. The precursor mixture may contain a third component initially present either as a portion of at least one of the first components or as a portion of at least one of the second components, or both, or as a separately added component. The third component may be selected from wollastonites, magnesium silicates, olivines, silicon dioxides, silicon carbides, silicon nitrides; calcium, potassium, sodium, barium, magnesium, iron, zinc, lithium, and ammonium, oxides, chlorides, nitrides, nitrites, carbides, carbonates, hydrocarbonates, fluorides, fluorites, sulfates, and phosphates; dolomites, titanium oxides, boric acids, boron oxides, hydrous tetraborates, anhydrous tetraborates, boron nitrides, boron carbides, colemanites, aluminum borates, zinc borates, calcium borates, magnesium borates, bauxites, kaolinites, clays, aluminas, aluminum hydroxides, alumina containing metallurgy slags, micas, alumina-containing fluid cracking catalyst particles, aluminum silicates; aluminum chlorides, nitrides, carbides, sulfates, fluorides, iodates, and bromides; calcium carbides; bentonite and illite clays; feldspars, nepheline syenites, talcs, fly ashes, alumina microspheres, aluminum silicate cenospheres, and mixtures of these.

The ceramic proppant may include one or more types of fibers selected from organic fibers, inorganic fibers, and fibers produced from slags.

The ceramic proppant may also be coated with a resin coating, preferably selected from an epoxy resin and a phenol-formaldehyde resin. The epoxy resin is preferably an isopropylidenediphenol-epichlorohydrin resin. The resin may be applied in one or two coats that may be the same or different resins.

Another embodiment is a method of making the ceramic proppant described above. The method involves the steps of combining one or more than one of the first components and one or more than one of the second components, and, if present, one or more than one of the third components to form a precursor mixture, adding water in an amount of from 5 to 25% by weight of the precursor mixture, mixing in a device having a rotatable horizontal or inclined table and a rotatable impacting impeller to form pellets, and calcining the resultant product at from 1300 to 1600° C.

Prior to the formation of the precursor mixture at least one component of the precursor mixture may be at least partially dehydrated by precalcination. Prior to the precalcination step at least one component of the precursor mixture may be ground to promote dehydration. The precursor mixture may optionally contain one or more than one of a binding agent and a dispersing agent. After the step of mixing to form pellets, a polishing agent may be added to the mixer and rotating continued; the polishing agent preferably has the same composition as the precursor mixture. Prior to the mixing and after the precalcination, if performed, at least one component of the precursor mixture may be comminuted, so that at least 90% of the component is smaller than 0.044 mm

Yet another embodiment is a method of fracturing a subterranean formation involving injecting a fluid containing the proppant of the Invention into the formation at a rate and pressure sufficient to fracture the formation.

### DETAILED DESCRIPTION

Embodiments are described for hydrocarbon production wells, but it is to be understood that the Invention may be used for wells for production or injection of other fluids, such as water or carbon dioxide or, for example, for injection or storage wells. Although some of the following discussion emphasizes fracturing, the proppant and methods of the Invention may be used in fracturing, gravel packing, and combined fracturing and gravel packing in a single operation. The embodiments will be described in terms of treatment of vertical wells, but is equally applicable to wells of any orientation. Some embodiments of the invention will be described for hydrocarbon production wells, but it is to be understood that embodiments may be used for wells for production of other fluids, such as water or carbon dioxide, or, for example, for injection or storage wells. It should also be understood that throughout this specification, when a concentration or amount range is described as being useful, or suitable, or the like, it is intended that any and every concentration or amount within the range, including the end points, is to be considered as having been stated. Furthermore, each numerical value should be read once as modified by the term “about” (unless already expressly so modified) and then read again as not to be so modified unless otherwise stated in context. For example, “a range of from 1 to 10” is to be read as indicating each and every possible number along the continuum between about 1 and about 10. In other words, when a certain range is expressed, even if only a few specific data points are explicitly identified or referred to within the range, or even when no data points are referred to within the range, it is to be understood that the inventors appreciate and understand that any and all data points within the range are to be considered to have been specified, and that the inventors have possession of the entire range and all points within the range.

Data analysis has shown that the permeability of proppant packs depends directly on the content of aluminum oxide and silicon dioxide in the material from which the proppant is made; the aluminum oxide/silicon dioxide ratio determines the quantitative ratio of phases in the calcined material. The important factors are the strength and density of the proppant. However, for previously known proppant materials, strengthening of the materials during the calcining process results from the generation in the material of phases whose compositions belong to the Al₂O₃—SiO₂ systems. The valuable properties possessed by these phases (e.g. high strength, as well as needle-shaped crystal structures that have a reinforcing effect on the material, as in the case of mullite) ensure sufficient strength of such proppants even if the compositions of the materials include vitreous phases that usually reduce the strength of ceramic products.

The strength of the material may be increased if phases differing in composition from, for example, corundum and mullite but also having high strength properties are also generated in the material. We have previously found that such additional desirable phases may, for example, be aluminum borates and aluminum boron silicate phases or their solid solutions with alumina and aluminum silicate. Such improved proppant materials were disclosed in WO2008004911 (US App. Pub. No. 20080009425), incorporated herein by reference thereto.

When alumina and boron oxides from the precursors react with each other, the synthesis of an aluminum borate phase (9Al₂O₃.2B₂O₃) occurs. Very importantly, we previously found (WO2008004911 (US20080009425)) that this synthesis proceeds with the formation of microporosity caused by the differences in the densities of the reagents and products. This microporosity decreases the density of the final product; however, the high strength of the aluminum borate phase allows retention of the high strength of the product. The volume changes of the different reagents causing the density decreases are presented in the Table 1 (the volume changes during the reaction between different aluminum and boron oxide precursors in alumina borate phases).

Because the alumina borates are structural analogs of the aluminum silicates, for example mullite (3Al₂O₃x2SiO₂), these two types of materials are able to form a continuous series of solid solutions with each other. This facility may be used to decrease the firing temperature of the material and/or to improve the strength of the material.

The alumina precursor may be chosen from the components typically used to make ceramic proppants, including for example clays, bauxites, aluminas, transition forms of aluminas, waste products, etc.

The boron-supplying component may be chosen from a variety of boron containing compounds that are traditionally used in ceramic and glass manufacturing.

The following definitions will be used in this specification and claims:

Bauxite is an aluminum ore. As mined, it typically consists largely of the aluminum hydrates, along with iron oxides, the clay mineral kaolinite and small amounts of anatase (titanium dioxide). Depending upon the deposit, bauxites may vary in alumina content significantly. The best results in manufacturing strong and light proppant material have been obtained with the use of bauxites having an alumina content in the range of 70-85 weight percent. The bauxite used in the experiments described below had an alumina content of at least 70 weight %; the rest was from 5 to 27.8% silica, 1 to 5% magnesia, 0.1 to 5% titania, 1 to 5% calcium oxide, and 0.1 to 5% iron oxides.

Clay (or clay minerals) is a term used to describe a group of hydrous aluminum phyllosilicate (phyllosilicates being a subgroup of silicate minerals) minerals, that are typically less than 2 μm (micrometers) in diameter. Clay consists of a variety of phyllosilicate minerals rich in silicon and aluminum oxides and hydroxides, which include variable amounts of structural water. Proppants previously have best been produced using kaolin clay, which contains less impurities than most clays; the impurities would reduce the final strength of ceramics because they result in the formation of the formation of weak glass phases.

There are two reasons why clays are used; they relate to manufacturing issues. First, the use of clays allows the manufacture of sufficiently strong proppant at low firing temperatures; second, clays plasticize non-plastic bauxites so it is possible to mold strong green (not dried or calcined) pellets during the pelletizing stage. In this invention, clays may be used to supply alumina and silica oxide to form the compounds, eutectics, and solid solutions in the desired Al₂O₃/SiO₂/B₂O₃ systems.

Although ceramics manufactured starting with “pure alumina” (having an alumina content of more than 90 weight percent) are among the strongest ceramic materials, pure alumina is usually not used in proppant manufacturing because it requires high firing temperatures, resulting in increased manufacturing costs. However, since fines are used in the methods of making proppants, pure alumina fines (e.g., stable alpha, gamma, zeta and other transition and metastable alumina forms) may be used as one of the components of the raw materials or as the only alumina precursor. Fines may be waste products and less expensive than other aluminas.

Important properties of proppant packs are their conductivity and permeability, which depend directly on the strength of the material from which the proppant is made (because proppant crushing seriously reduces these properties). We have previously found that systems based on various aluminum borates and alumina borosilicates (as well as solid solutions and eutectic mixtures of silicon dioxide, mullite, corundum, and boron oxide with the above-mentioned compounds) may be used as highly desirable proppant material, ensuring that high-strength proppants are obtained.

We have now found that during the reaction between alumina, silica, and boron containing precursors, in the presence of additional components (e.g., inorganic salts, metallic oxides or impurities supplied from the raw materials, that allow enhancement of the synthesis of targeted phases and/or improvement of the sintering process) at the temperatures typically used in the ceramic manufacturing process, additional desirable high-strength phases are formed. Furthermore, the impure precursor components, or the added components, are less expensive and often more readily available than the previously used more pure components; better products may be made from less expensive starting materials.

We describe here a composition and method of manufacturing of gas and oil well proppants. The proppant is a plurality of sintered, approximately spherical pellets. These pellets are prepared from a composition including at least one component from Group A below (alumina precursors) and at least one component from Group B below (boron oxide precursors). If at least one of the components from Group A and/or one of the components from Group B contains sufficient impurities to give the desired properties, then that is sufficient. If each is relatively pure, then a component from group C is needed. To improve the crush strength, a special coating is added.

Group A:

Examples include bauxites, kaolins, clays, alumina fines, aluminum hydroxides, alumina containing metallurgy slags (ferrous and non-ferrous), powders of aluminum oxides (in transition states), mica, alumina-containing spent fluid cracking catalyst particles, aluminum silicates (for example mullite, kianyte, sillimanite), alumina chloride, alumina nitride, alumina sulfate, alumina floride, alumina idodate, alumina bromide, aluminum borate, and aluminum boron silicate.

Group B:

Examples include boric acid, boron oxide, hydrous and anhydrous tetraborate, boron nitride, boron carbide, colemanite, aluminum borate, zinc borate, calcium borate, and magnesium borate.

At least one component of Group A and at least one component of Group B is always present in the raw materials from which the proppant is manufactured. If at least one of these components contains impurities suitable for improving the final proppant properties, then only these materials are needed. If the components selected from Group A and Group B do not contain sufficient impurities, then the raw material mixture will contain at least one of the following additives (Group C) that improve the strength and/or reduce the apparent specific gravity of the final proppant material.

Group C:

Wollastonite, magnesium silicates (for example forsterite and steatite), olivines (solid solutions of magnesium and ferrous silicates), silicon dioxide, silicon carbide, silicon nitride; calcium, potassium, sodium, barium, magnesium, iron, zinc, lithium, and ammonium, oxides, chlorides, nitrides, nitrites, carbides, carbonates, hydrocarbonates, fluorides, fluorites, sulfates, and phosphates; dolomite, titanium oxide, boric acid, boron oxide, hydrous and anhydrous tetraborate, boron nitride, boron carbide, colemanite, aluminum borate, zinc borate, calcium borate, magnesium borate, bauxites, kaolins, clays, alumina fines, aluminum hydroxides, alumina containing metallurgy slags (ferrous and non-ferrous), powders of aluminum oxides (in transition states), mica, alumina-containing spent fluid cracking catalyst particles, aluminum silicates (for example mullite, kianyte, and sillimanite); aluminum chloride, nitride, carbide, sulfate, floride, idodate, and bromide; calcium carbide, bentonite and illite clays, feldspar, nepheline syenite, talc, fly ash, alumina microspheres, aluminum silicate cenospheres, organic and inorganic fibers, and fibers produced from slags. The special coating is described below.

Method of Preparation

We have further found that specific manufacturing methods may be employed to improve and optimize the final properties of the proppants, in particular their strength and density.

At least one component of Group A is mixed with at least one component of Group B to make the starting material. Optionally at least one of the components from Group C may be introduced into the mixture to modify the strength and/or the density of the final proppant to be made.

Prior to the mixing, at least one component from Group A, and/or at least one component from Group B, and/or at least one component from Group C may optionally be pre-calcined to partially or completely dehydrate that component. The material may be calcined by methods well known to those of ordinary skill in the art, at temperatures and times to partially or completely remove sufficient water of hydration to facilitate subsequent pelletization.

Prior to the precalcination at least one component from Group A, and/or at least one component from Group B, and/or at least one component from Group C may be ground to a size distribution sufficient to provide the desired level of dehydration at the temperatures and times known to those of ordinary skill in the art.

Prior to the mixing and after the precalcination, at least one component from Group A, and/or at least one component from Group B, and/or at least one component from Group C may optionally be milled to a size of 90-100 percent less than 325 mesh (smaller than 0.044 mm) by either a dry or wet method known to those of ordinary skill in the art. If more than one component is ground, the components may be ground separately or together.

At least one component from group A and/or at least one component from group B, and/or optionally at least one component from Group C, may be mixed and milled to 90-100 percent less than 325 mesh (less than 0.044 mm) simultaneously or separately by dry or by wet methods known to those of ordinary skill in the art.

If at any stage the milling and/or mixing are performed wet, a step of drying of the ceramic-precursor or ceramic slurry may be introduced into the manufacturing method to improve the formulation, milling, mixing and pelletizing steps.

Optionally a binding agent may be included in the precursor material mixture, and optionally the drying agent may be milled prior to introduction into the raw material mixture.

The starting materials from Group A and Group B, and optionally Group C, and optionally a binding agent (for example starch, carboxymethyl cellulose, methylcellulose, polyvinyl alcohol, guars, and other plasticizing components known in industry) are mixed using a suitable commercially available stirring or mixing device, for example one having a rotatable horizontal or inclined circular table and a rotatable impacting impeller.

While the mixture of raw materials is being stirred, if the mixture of raw materials contains a dry binding agent, sufficient water is added to cause formation of spherical pellets and growth of those pellets to the desired size. Alternatively, a solution or wet gel of the binding agent may be added t provide the binding agent and water in one step.

Special additives that allow decreased liquid consumption during the pelletizing stage may optionally be introduced into the mixture. Water is typically used to provide the nucleation of grain seeds and the further growth of these seeds into pellets; in other words, water is used to promote aggregation of the fine particles of the raw material. Usually, to promote this process and to increase the strength of the pellets as they form, special binding additives are added. Examples include, for example, starch, polyvinyl alcohol, carboxymethylcellulose, lignosulfonates, latexes, and others, known to those skilled in the art. It is also known that some binding additives such as, for example, polyvinyl alcohols and lignosulfonates may act as dispersants, reducing the amount of liquid phase required for the pelletizing process. Any other dispersants (for example, cationic, non-ionic, and anionic) may be employed during this process. Examples include sodium silicates, sodium hehamethaphosphases, piperine, sodium gluhephanate, carboxylates, polyacrylic acids, salts and their derivatives. The usual concentration is from 0.05 to 1% by weight of the solid.

In general, the total quantity of water, which is sufficient to cause essentially spherical pellets to form, is from 5 to 25 percent by weight of the starting ingredients. The total mixing time usually is from 2 to 25 minutes.

At the end of the pelletizing process, a quantity of at least one of the ingredients from the groups A, B, and optionally C, may be added to the mixer in order to make the surface of the proppant smoother and to fill at least a portion of the porosity of the pellets. The quantity of this portion, referred to as a polishing agent, is from 0.5-50 percent of the weight of the pellets, preferably from 10-25 weight percent. The polishing agent may have the same composition as the pellet precursor mixture; may be the same as any one or two of the precursor mixture components; or may contain components that differ from those in the precursor mixture. Preferably, the polishing agent has the same composition as the initial precursor mixture. The particles of polishing agent should be smaller than 100 mesh (0.15 mm), preferably smaller than 325 mesh (0.044 mm), preferably with at least 90% in the 3 to 12 micron range. The components of the polishing agent may form a melt during one or both of the heat treatment stages (drying and calcining) at temperatures below or equal to the maximum temperature of the heat treatment.

After completion of the palletizing process, the pellets are dried to remove the liquid used in the pelletizing process and are sieved to isolate the desired mesh size. Drying is typically done at from 122 to 212° F. (50 to 100° C.); the time needed depends upon the temperature and is easily determined by simple experiment. The lower temperatures may be needed if components, for example boric acid, have some volatility. Oversized and undersized green pellets may be recycled and processed again.

Optionally a quantity of inorganic or metal or organic fibers, or a mixture of such fibers, may be added before or after the pelletizing, optional polishing step, or drying step in order to increase the strength of the proppant.

The heat treatment stages, including drying and calcining, are performed at final temperatures up to 1600° C., preferably in the temperature range of 1300 to 1450° C. with the heating rate, and the residence time at the final temperature, selected to obtain the phase composition or compositions providing the best properties of the ceramic body. Optionally, the material may also be held for a period of time at an intermediate temperature to improve the final properties. After the firing, the proppant pellets are cooled down sufficiently slowly to prevent cracking of the pellets due to thermal shock.

After the cooling, the proppant may be sieved to the appropriate mesh size range. It is an aspect of the Invention that then at least one of a polymer or metal (for example aluminum, iron, and titanium) or inorganic or composite coating (curable or pre-curable) may be applied to the surface of the proppant by any method known to those of ordinary skill in the art. For example, curable and pre-cured phenol-formaldehyde, furan, and epoxy resins and their derivatives may be used. In addition, such coatings as polyethylene, polypropylene, and TEFLON™ may be applied to the surface of the substrate. Ceramic coatings, for example aluminum oxide, titanium oxide, silicon carbide, silicon nitride, magnesium oxide, mullite, alumina, borate, and others, may also be used.

Such a coating, for example a resin coating, allows the preparation of a lighter material that none-the-less gives a proppant with a greater crush strength, that produces a proppant pack with better permeability, as compared to the same proppant without the coating.

The coating on the proppant of the Invention may be a single cured or precured layer of resin; it may be two cured resin layers; and it may be a first (inner) precured and a second (outer) cured layer of resin. However, one preferred type of coating consists of a first (inner) precured resin coating and a second precured (outer) resin coating. One type of resin may be used for the inner layer of the coating and another one for the outer layer. Another preferred method of coating of the Invention is a method for producing a precurable dual resin coated proppant. Curable resin coated particles are produced by first coating the substrate with a first reactive resin and then curing that resin. A second coating of a second curable resin is then coated over the inner cured resin layer and then cured as well.

The presence of the inner cured coating allows closure of the porous surface of the light weight proppant material and further allows minimized consumption of resin; at the same time, a high strength of the final coated material is obtained. Resins suitable for the inner and outer coatings are generally any resins that can be cured to a higher degree of polymerization. The resins must form a solid coating at ambient or elevated temperatures to prevent particles from agglomerating at normal storage conditions; the final particles must capable of flowing.

Resins suitable for use in the coatings include polyurethane resins, alkyd resins (for example, glyptal and pentaerythritol-modified phthalic resins, for example modified by natural oils), acrylic resins (especially water dispersed resins because of their ease of use), epoxy and phenol-formaldehyde resins, and their derivatives. These resins may be used in solutions and as dry powders. Among the listed compounds, polyurethane resins are the strongest substances, but alkyd resins are easily cured at normal conditions. Both polyurethane and acrylic resins have a great advantage when used in solution: these resins are the least harmful to workers and the environment, and, they may be dissolved in aqueous systems. All these resin products provide good quality coverage and good performance properties. These resins may include: additives for adhesion improvement; additives for elasticity improvement; additives for providing curing under special conditions; etc. Special additives for improving strength characteristics may also be added to the resins; examples are reinforcing organic, metal, ceramic or mineral particles (powders).

Preferred additives are carboniferous, polymeric, boron and glass fibers. Fiber-reinforced coated proppants are better able to withstand the closure stress experienced in a fracture. These additives help in maintaining better formation permeability and they reduce the flow-back of particles. Basalt fibers are a good example for improving coatings performance; they have a positive effect on the operating characteristics of coatings and on proppant bridging propensity as well.

Inner and outer coatings can be comprised of the same types of resin or different resins. Coupling agents are typically used to bond the coating to the substrate and to bond different coating layers to one another; they are chosen based on the resin or resins to be used. When used, coupling agents are preferably incorporated into the resin composition to be used as a coating during its manufacture. Not all suitable resins require the coupling agents.

Suitable resins, for example, those listed above, provide new lightweight strong proppants with better properties because the polymeric resins fill and cover the porous surface of the proppant and so prevent fines generation. We have found that a particularly suitable epoxy resin for this special use is a 4,4-isopropylidenediphenol-epichlorohydrin resin manufactured by 3M™ (St. Paul, Minn., U.S.A.) and sold under the name Scotchcast™ Electrical Resin 265. Epoxy resin coated proppants are known, but 4,4-isopropylidenediphenol-epichlorohydrin resins are known for insulation of electrical components, but not for proppant coating.

Methods suitable for coating the new type of light-weight proppant of the Invention include the following. For soluble resins, a wet method of coating is preferred (for example, a roll-on method); for powdered resins, a dry method is preferred. A suitable-capacity reactor having branch pipes for loading of components may be used in both wet and dry methods. In the wet method, proppant material and soluble resin in a solvent, preferably water, are loaded into the reactor; during mixing, solvent evaporates from the system through special connecting branches. The proppant coating is then cured at the appropriate temperature in the oven if required, depending on the type of resin. In the dry powder resin method, proppant is mixed with the resin compound in the reactor at a suitable temperature, and then the coating is cured in the same reactor. In either case, special agents for improving adhesion (or other properties) may be added.

In a typical preparation, the first or inner coating of resin is formed on the particulate substrate (proppant) by coating the heated substrate with a dissolved resin composite. This coating is carried out by preheating the particulate substrate, for example to a temperature of 100° C., and then slightly cooling to the preferred temperature of the coating process. The preheated substrate is charged to a suitable reactor (for example at a concentration of from 2.0% to 7.0% of the capacity of the reactor), and then soluble resin is added (in the form of a solution). After the proppant is added to the reactor, the mixing process is started, and the soluble polymer is injected into the reactor containing the substrate. The recommended rotary speed is in the range of from 50 rpm to 300 rpm. The mixing process is carried out at normal pressure and at a constant temperature that is close to or lower than the boiling point of the solvents. The reactor should have sufficient branch pipes for loading of the substrate and of the resin solution resin, and for bleeding off of the solvent vapors. After all the solvent is removed from the surface of the material, the coated material is kept in the oven at a temperature that allows the resin to cure. The technology for depositing the outer coating is typically the same as for the inner one; a common difference may be in the amount of coating resin. The total coating may be up to 15% by weight of the proppant, but the recommended final coating on the particles is in range from 2.0 wt. % to 7.0 wt. % of resin.

Optionally, at least a portion of the porosity of the proppant may be filled with at least one of the chemical components commonly introduced into a hydraulic fracture with the hydraulic fracturing fluid; examples include crosslinkers, breakers, scale inhibitors, fluid loss additives, and others.

We have found that proppants are particularly strong when the initial mixture base composition has an alumina-to-boron oxide weight ratio (on a dry basis) of from 98:30 to 2:70. We have found that further improved properties are obtained if the mixture optionally also contains from 0.5 to 50 weight percent of other oxides (on a dry weight basis using the preceding base composition as 100 percent.) We have further found that additionally improved properties are obtained if the mixture optionally also contains from 0.5 to 70 weight percent of silica (on a dry weight basis using the base composition as 100 percent). Optionally the mixture may contain both the added silica and the added other oxides within the amounts indicated.

With suitable choices of compositions as described above, and with optimized drying and calcination temperature and time profiles, the apparent specific gravity of the final product may be from 0.8 to 2.7, for example from 1.2 to 2.2, or even from 0.2 to 1.35. These results may be obtained by one of ordinary skill in the art without undue experimentation.

The approximately spherical, sintered pellets are useful as propping agents in methods of fracturing subterranean formations to increase their permeability, particularly those formations having a compaction pressure of up to 10,000 psi (14.88 kPa). The proppants obtained are used, for example, in fracturing a subterranean formation located at a depth of up to 10,000 feet (3048 meters), by injecting a hydraulic fluid into the formation at a rate and pressure sufficient to open a fracture, and injecting a fluid containing the proppant into the fracture. The preferred proppant concentration is in a range of from 0.06 to 1.44 kg/l (0.5 to 12 PPA (pounds proppant added)).

The invention may be understood further from the following examples.

### EXAMPLE 1

### COMPARATIVE EXAMPLE

An 85/15 weight ratio mixture of corundum (a substantially pure crystalline form of alumina) fines and boric acid was prepared by first grinding the mixture so that 99.4 percent of the mixture had a particle size of less than 325 mesh (less than 0.044 mm) Next, 4000 grams of the 85/15 weight ratio mixture was charged to an R02 Eirich mixer.

The mixer was operated at high-speed and 1200 grams of water containing 24 grams of methylcellulose as a binding agent was added. Pelletizing was continued with the high-speed rotor for 5 minutes. Next, the speed of the mixer rotor was reduced to “slow” and 250 grams of polishing dust having the same 85/15 ratio composition of corundum fines and boric acid was added. The polishing dust particles were smaller than 325 mesh (0.044 mm); 90% of the particles were in the range of 3 to 12 microns. The pellets were polished at the slow rotor setting for a total of 1.5 minutes.

The pellets were then dried at 194 F (90° C.) for 10 hour and screened to −20 mesh/+40 mesh (larger than 0.420 mm and smaller than 0.841 mm) prior to firing at a temperature of 1350° C. The resulting pellets had an alumina content of 84 weight % and an apparent specific gravity of 1.6.

The crush strength of the pellets was tested in accordance with the API procedure RP 60 for determining resistance to crushing; at an induced pressure of 10,000 psi (14.88 kPa), the pellets had a crush percentage of 6 weight percent, which meets the API specification of 10 percent maximum crush for this size proppant. However, this material has a comparatively low crush strength for its specific gravity.

### EXAMPLE 2

4000 grams of a 75/10/15 weight ratio mixture of intermediate strength bauxite, kaolin clay, and boric acid was ground so that the particle size was 99 percent through 325 mesh (less than 0.044 mm) and was added to an R02 Eirich mixer. The alumina content of the overall composition was 52%.

The mixer was operated with the rotor at high speed, and 650 grams of water containing 6 grams polyvinyl alcohol (as a binder) was added. Rotation of the table and impeller was continued for 7 minutes; subsequently, the impeller speed was decreased and 300 grams of polishing dust (particles smaller than 325 mesh (0.044 mm), 90% in the range of 3 to 12 microns) having the same 75/10/15 ratio composition of bauxite, kaolin clay and boric acid was added incrementally. Polishing continued for approximately 2 minutes.

The pellets were then dried and screened to −20 mesh/+40 mesh (larger than 0.420 mm and smaller than 0.841 mm) prior to firing at 1400° C. The resulting pellets had an apparent specific gravity of 1.55, and a sphericity of greater than 0.8, as determined using the Krumbein and Sloss chart.

The light weight ceramic product was then coated with two layers to provide the proppant with better performance properties, especially to improve the crush strength of the proppant. The resin used was an epoxy resin manufactured by 3M™ (St. Paul, Minn., U.S.A.) and sold under the name Scotchcast™ Electrical Resin 265. The pellets obtained were coated with the epoxy resin using a wet method (a roll-on method). This method was used for both layers of coating in a two-step process. In the first step, a cured epoxy resin inner coat was formed on the particulate substrate. In the next step a second or outer resin coating was formed on the inner coating. The procedure was as follows:
1. 4.00 lbs (1814.36 g) of 20/40 mesh (larger than 0.420 mm and smaller than 0.841 mm) light weight proppant of the Example was charged to the oven and heated to 100° C. Then the material was cooled to 45-50° C.
2. 0.08 lbs (36.28 g, 2% by mass of proppant) of Scotchcast™ Electrical Resin 265 was dissolved in acetone (720 ml).
3. The heated light weight proppant was loaded into a laboratory reactor.
4. A solution of resin (240 ml) was injected into the reactor (using a total of 3 injections of resin) every 15-20 min during mixing at 80 rpm. For complete solvent evaporation 60-70 min of mixing was required.
5. After mixing, the coated proppant was placed in the oven at 150° C. to cure for 60 min.
6. After curing the process, the material was cooled to 45-50° C. and loaded into the reactor.
7. The coating process was repeated at the same conditions, but the amount of resin was increased. 0.16 lbs (72.57 g) of resin were dissolved in acetone (1400 ml) to coat the proppant with an outer cover.
8. For the outer coat, 5 injections of resin were performed (each 280 ml of solution) at 15-20 min intervals.
9. The curing of the second layer was carried out at the same conditions (150° C., 60 min) as the first.
10. After cooling of the material the grain size distribution of was measured.

The crush strength of the pellets was tested in accordance with the API procedure for determining resistance to crushing noted above; at an induced pressure of 7,500 psi (11.16 kPa) the pellets had a crush percentage of 3 weight percent, which meets the API specification of 10 percent maximum crush for this size proppant.

### EXAMPLE 3

3500 grams of a 60/35/5 weight ratio mixture of kaolin clay, calcined intermediate grade bauxite, and boron oxide was ground, so that the mixture had a particle size of 99.9 percent through 325 mesh (less than 0.044 mm), and was added to an R02 Eirich mixer. The mixture had an overall alumina content in the mixture of 51 wt %.

The mixer was operated with the rotor high at speed and 400 grams of water was added. Rotation of the table and impeller was continued for 5 minutes; subsequently, the impeller speed was decreased and 350 grams of polishing dust having the same 60/35/5 ratio mixture (particles smaller than 325 mesh (0.044 mm), 90% in the range of 3 to 12 microns) of kaolin clay, calcined bauxite and boron oxide was added incrementally (five 70 g portions, added at 8.5 sec intervals). Polishing continued for approximately 1 minute. Then, 100 g water containing 1 weight percent of polyvinyl alcohol (as a binder) was sprayed through the nozzle onto the surface of the pellets while the rotation was continued at the same speed. Then, 350 g of wollastonite crystal needles having an aspect ratio of 10 and a maximum size of less than 325 mesh (less than 0.044 mm) was added to the mixer. The rotation was continued for 2 more minutes.

The pellets were then dried and screened to −20 mesh/+40 mesh (larger than 0.420 mm and smaller than 0.841 mm) prior to firing at 1300° C. The resulting pellets had an apparent specific gravity of 2.2, and a sphericity of greater than 0.8, as determined using the Krumbein and Sloss chart.

After the pellets were made, they were coated with a commercially available epoxy resin (the same one used in Example 2) to improve the crush strength of the proppant. The grains of proppant were coated with resin using a dry method (a roll-on method), and the same equipment was used as was used above. In this case, the coating was one layer only; it was a precured coat. A cured epoxy resin coating was formed on the particulate substrate in the reactor during mixing. The procedure was as follows:
1. 4.00 lbs (1814.36 g) of 20/40 mesh (larger than 0.420 mm and smaller than 0.841 mm) light weight proppant of Example 3 was charged to the oven and heated to 100° C. The material was then cooled to 60-70° C.
2. 0.24 lbs (108.86 g, 6% by mass of proppant) of SCOTCHCAST™ Electrical Resin 265 was prepared for loading into the reactor.
3. The heated light weight proppant was loaded into the laboratory reactor.
4. Powdered resin was loaded into the reactor in portions (10 g of resin every 8 min) during mixing at 80 rpm. For the complete process, abut 90 min of mixing was required.
5. After the mixing, the coated proppant was put into the oven at 150° C. to cure for 60 min During the curing process, the proppant was moved (mixed) in the oven to prevent agglomeration of the coated light weight proppant.
6. After cooling the material, the grain size distribution was measured.

It is also possible to cover the new light weight proppant additive of the Invention with a double coating using this method, in which case one or both of the resin layers may be precured.

The crush strength of the pellets was tested in accordance with the API procedure for determining resistance to crushing noted above; at an induced pressure of 7,500 psi (11.16 kPa) the pellets had a crush percentage of 6 weight percent, which meets the API specification of 10 percent maximum crush for this size proppant.

### EXAMPLE 4

3800 grams of a 50/43/7 weight ratio mixture of alumina silicate cenospheres having an alumina content of 25-35%, intermediate grade bauxite, and sodium tetraborate was added to an R02 Eirich mixer. The bauxite and sodium tetraborate had a particle size of 99.9 percent through 325 mesh (less than 0.044 mm) and the mean size of the cenospheres was 140 mesh (0.105 mm) The alumina content of the overall composition was 55%.

The mixer was operated with the rotor high at speed and 800 grams of water containing 2.5 weight percent of starch (as a binder) was added. Rotation of the table and impeller was continued for 9 minutes; subsequently, the impeller speed was decreased and 350 grams of polishing dust (particles smaller than 325 mesh (0.044 mm)) having the same 86/14 ratio composition of bauxite and sodium tetraborate was added incrementally (five 70 g portions, added at 8.5 sec intervals). Polishing continued for approximately 1 minute.

The pellets were then dried and screened to −20 mesh/+40 mesh (larger than 0.420 mm and smaller than 0.841 mm) prior to firing at 1350° C. The resulting pellets had an apparent specific gravity of 1.1, and a sphericity of greater than 0.8, as determined using the Krumbein and Sloss chart.

After screening, the pellets were coated with a commercially available phenol formaldehyde epoxy resin using dry method of coating (roll-on method), to improve the crush strength of the proppant. The equipment used has been described. The phenol-formaldehyde coating was applied onto the surface of the proppant and then cured. Two cured coatings were produced on the substrate as follows:
1. 4,00 lbs (1814.36 g) of 20/40 mesh (larger than 0.420 mm and smaller than 0.841 mm) pellets was charged to the oven and heated to 100° C. The material was then cooled to 60-70° C.
2. The pellets were then loaded into the laboratory reactor used before.
3. 0.24 lbs (108.86 g; 6% by mass of proppant) of phenol-formaldehyde resin was loaded into the reactor in portions (10 g of resin every 8 min) while mixing at 80 rpm. For the complete process of rolling, 90 min of mixing was required.
4. After mixing, the coated proppant was put into the oven at 150° C. to cure for 60 min. During the curing process, the proppant was moved (mixed) in the oven to prevent agglomeration of the coated proppant.
5. Steps 2 through 4 were repeated to form the second layer of cured resin.
6. After cooling of the material the grain size distribution of the composition of the Invention was measured.

The crush strength of the pellets was tested in accordance with the API procedure for determining resistance to crushing noted above; at an induced pressure of 5000 psi (7.44 kPa) the pellets had a crush percentage of 8 weight percent, which meets the API specification of 10 percent maximum crush for this size proppant.

### EXAMPLE 5

4000 grams of a 75/10/15 weight ratio mixture of intermediate grade bauxite having an alumina content of 68%, kaolin clay, and boric acid, having a particle size of 99 percent through 325 mesh (less than 0.044 mm) was added to an R02 Eirich mixer. The overall alumina content of the mixture was 54%.

The mixer was operated with the rotor high at speed and 400 grams of mullite fibers having an aspect ratio of 15 were subsequently added, and the rotation of the table and impeller was continued for 5 min Then 1200 gram of water containing 5 weight percent of polyvinyl alcohol (as a binder) was added. Rotation of the table and impeller was continued for 10 minutes; subsequently, the impeller speed was decreased and 300 grams of polishing dust having the same 75/10/15 ratio composition (particles smaller than 325 mesh (0.044 mm), of bauxite, kaolin clay and boric acid was added. Polishing continued for approximately 2 minutes.

The pellets were then dried and screened to −20 mesh/+40 mesh (larger than 0.420 mm and smaller than 0.841 mm) prior to firing at 1400° C. The resulting pellets had an apparent specific gravity of 1.55, and a sphericity of greater than 0.8, as determined using the Krumbein and Sloss chart.

After manufacture, the light weight ceramic proppant was coated in a two-step process, using the wet method of coating (roll-on method) for both layers of coating. In the first step, a cured epoxy resin inner coat was formed on the particulate substrate. In the second step, a second or outer resin coating was formed over the inner coating. The procedure was as follows:
1. 4,00 lbs (1814.36 g) of 20/40 mesh (larger than 0.420 mm and smaller than 0.841 mm) light weight proppant of the Invention was charged to the oven and heated to 100° C. The material was then cooled to 45-50 C.
2. The heated light weight proppant was loaded in the laboratory reactor.
3. 0.08 lbs (36.28 g; 2% by mass of proppant) of Scotchcast™ Electrical Resin 265 was dissolved in acetone (720 ml).
4. A solution of resin (240 ml) was injected into the reactor (a total of 3 injections of resin) every 15-20 min during mixing at 80 rpm. For complete solvent evaporation, 60-70 min of mixing was required.
5. After mixing, the coated proppant was put into the oven at 150° C. to cure for 60 min.
6. After the curing process, the material was cooled to 45-50° C. and loaded into the reactor.
7. The coating process was repeated under the same conditions, with the same amount of resin.
8. For the outer coat, 5 injection of resins were used (280 ml of solution each) at 15-20 min intervals.
9. Curing of the second layer was carried out at the same conditions (150° C., 60 min) as the first.

The crush strength of the pellets was tested in accordance with the API procedure for determining resistance to crushing noted above; at an induced pressure of 7,500 psi (11.16 kPa) the pellets had a crush percentage of 3 weight percent which meets the API specification of 10 percent maximum crush for this size proppant.

TABLE 1

| | dV/V, |
|---|---|
| Chemical Reaction | % |
| 9 α-Al₂O₃ + 4 H₃BO₃ → 9 Al₂O_{3•}2B₂O₃ + 6 H₂O | −8.7 |
| 9 γ-Al₂O₃ + 4 H₃BO₃ → 9 Al₂O_{3•}2B₂O₃ + 6 H₂O | −15.0 |
| AlOOH + H₃BO₃ → 9 Al₂O_{3•}2B₂O₃ + 6 H₂O | −34.5 |
| Al(OH)₃ + H₃BO₃ → 9 Al₂O_{3•}2B₂O₃ + 6 H₂O | −47.5 |

Having thus described our invention, we claim:

1. A ceramic proppant comprising a plurality of sintered spherical pellets, prepared from a precursor mixture comprising at least a first component selected from alumina, a mineral comprising aluminum oxide, an inorganic salt, a metallic oxide wherein the metal is not all aluminum, an impure alumina, and mixtures thereof, wherein if the first component comprises alumina or an inorganic salt it must comprise at least one other first component, and a second component comprising a boron source, wherein said proppant comprises at least a first phase selected from the group consisting of aluminum borates, aluminum boron silicates, and solid solutions of these with alumina and aluminum silicate, and a second phase.

2. The ceramic proppant of claim 1, wherein the first component is selected from bauxites, kaolinites, clays, aluminas, aluminum hydroxides, alumina-containing metallurgy slags, micas, alumina-containing fluid cracking catalyst particles, aluminum silicates, alumina chlorides, alumina nitrides, alumina sulfates, alumina fluorides, alumina iodides, alumina bromides, aluminum borates, aluminum boron silicates, fly ash, and mixtures thereof.

3. The ceramic proppant of claim 1, wherein the second component is selected from boric acids, boron oxides, hydrous tetraborates, anhydrous tetraborates, boron nitrides, boron carbides, colemanites, aluminum borates, zinc borates, calcium borates, magnesium borates, and mixtures thereof.

4. The ceramic proppant of claim 1 wherein the precursor mixture further contains a third component initially present either as a portion of the at least one member of the first group or as a portion of the at least one member of the second group, or both, or as a separately added component, said additional component selected from a third group consisting of wollastonites, magnesium silicates, olivines, silicon dioxides, silicon carbides, silicon nitrides; calcium, potassium, sodium, barium, magnesium, iron, zinc, lithium, and ammonium, oxides, chlorides, nitrides, nitrites, carbides, carbonates, hydrocarbonates, fluorides, fluorites, sulfates, and phosphates; dolomites, titanium oxides, boric acids, boron oxides, hydrous tetraborates, anhydrous tetraborates, boron nitrides, boron carbides, colemanites, aluminum borates, zinc borates, calcium borates, magnesium borates, bauxites, kaolinites, clays, aluminas, aluminum hydroxides, alumina containing metallurgy slags, micas, alumina-containing fluid cracking catalyst particles, aluminum silicates; aluminum chlorides, nitrides, carbides, sulfates, fluorides, iodates, and bromides; calcium carbides; bentonite and illite clays; feldspars, nepheline syenites, talcs, fly ashes, alumina microspheres, aluminum silicate cenospheres, and mixtures thereof.

5. The ceramic proppant of claim 1 further comprising one or more types of fibers selected from organic fibers, inorganic fibers, and fibers produced from slags.

6. The ceramic proppant of claim 1 further comprising a resin coating.

7. The ceramic proppant of claim 6 wherein the resin is selected from an epoxy resin and a phenol-formaldehyde resin.

8. The ceramic proppant of claim 7 wherein the epoxy resin is an isopropylidenediphenol-epichlorohydrin resin.

9. The ceramic proppant of any of claim 6 wherein the resin is applied in two coats that may be the same or different resins.

10. A method of making the ceramic proppant of claim 1, the method comprising the steps of combining one or more than one of the first components and one or more than one of the second components, and, if present, one or more than one of the third components, to form a precursor mixture, adding from 5 to 25% water by weight of the precursor mixture, mixing in a device having a rotatable horizontal or inclined table and a rotatable impacting impeller to form pellets, and calcining at from 1300 to 1600° C.

11. The method of claim 10 wherein prior to the formation of the precursor mixture at least one component of the precursor mixture is at least partially dehydrated by precalcination.

12. The method of claim 11 wherein prior to the precalcination step at least one component of the precursor mixture is ground to promote dehydration.

13. The method of claim 10 wherein the precursor mixture further contains one or more than one of a binding agent and a dispersing agent.

14. The method of claim 10 wherein after the step of mixing to form pellets, a polishing agent is added to the mixer and rotating continued, said polishing agent having the same composition as the precursor mixture.

15. The method of claim 10, wherein prior to the mixing and after the precalcination, if performed, at least one component of the precursor mixture is comminuted, so that at least 90% of the component is smaller than 0.044 mm.

16. A method of fracturing a subterranean formation comprising injecting a fluid into the formation at a rate and pressure sufficient to fracture the formation, said fluid containing proppant having a composition of claim 1.

17. The ceramic proppant of claim 16, wherein the first component is selected from bauxites, kaolinites, clays, aluminas, aluminum hydroxides, alumina-containing metallurgy slags, micas, alumina-containing fluid cracking catalyst particles, aluminum silicates, alumina chlorides, alumina nitrides, alumina sulfates, alumina fluorides, alumina iodides, alumina bromides, aluminum borates, aluminum boron silicates, fly ash, and mixtures thereof.

18. The ceramic proppant of claim 16, wherein the second component is selected from boric acids, boron oxides, hydrous tetraborates, anhydrous tetraborates, boron nitrides, boron carbides, colemanites, aluminum borates, zinc borates, calcium borates, magnesium borates, and mixtures thereof.

19. The ceramic proppant of claim 16 wherein the precursor mixture further contains a third component initially present either as a portion of the at least one member of the first group or as a portion of the at least one member of the second group, or both, or as a separately added component, said additional component selected from a third group consisting of wollastonites, magnesium silicates, olivines, silicon dioxides, silicon carbides, silicon nitrides; calcium, potassium, sodium, barium, magnesium, iron, zinc, lithium, and ammonium, oxides, chlorides, nitrides, nitrites, carbides, carbonates, hydrocarbonates, fluorides, fluorites, sulfates, and phosphates; dolomites, titanium oxides, boric acids, boron oxides, hydrous tetraborates, anhydrous tetraborates, boron nitrides, boron carbides, colemanites, aluminum borates, zinc borates, calcium borates, magnesium borates, bauxites, kaolinites, clays, aluminas, aluminum hydroxides, alumina containing metallurgy slags, micas, alumina-containing fluid cracking catalyst particles, aluminum silicates; aluminum chlorides, nitrides, carbides, sulfates, fluorides, iodates, and bromides; calcium carbides; bentonite and illite clays; feldspars, nepheline syenites, talcs, fly ashes, alumina microspheres, aluminum silicate cenospheres, and mixtures thereof.

20. The ceramic proppant of claim 16 further comprising at least one selected from a resin coating or one or more types of fibers selected from organic fibers, inorganic fibers, and fibers produced from slags.
